(19) United States
(12) Patent Application Publication
(10) Pub. No.: US 2020/0244195 A1
(43) Pub. Date: Jul. 30, 2020

(54) MOTOR CONTROL DEVICE AND MOTOR SYSTEM

(71) Applicant: DENSO CORPORATION, Kariya-city, Aichi-pref. (JP)

(72) Inventors: Kazunori SHIMADA, Kariya-city (JP); Toshihiro UCHIDA, Kariya-city (JP); Yoshiaki TAKEMOTO, Kariya-city (JP)

(73) Assignee: DENSO CORPORATION, Kariya-city, Aichi-pref. (JP)

(21) Appl. No.: 16/610,564

(22) PCT Filed: Jun. 7, 2018
(86) PCT No.: PCT/JP2018/021913

§ 371 Date: Nov. 4, 2019

(30) Foreign Application Priority Data
Jun. 21, 2017 (JP) 2017-121402

(51) Int. Cl. H02P 6/10; H02P 23/04

(52) U.S. Cl. CPC H02P 6/10; H02P 23/04

(57) ABSTRACT

A motor control device controls a two-phase motor. The two-phase motor obtains a combined torque, which serves as an output torque. The A-phase and B-phase motor portions being joined having a phase difference in terms of structure. The motor control device sets each of A-phase and B-phase drive currents supplied to the A-phase and B-phase motor portions to control the two-phase motor. The motor control device includes a fundamental wave setting unit that sets a sinusoidal fundamental wave current of the A-phase and B-phase drive currents, and a superimposing wave setting unit that sets a high-order harmonic current superimposed on the fundamental wave current. The superimposing wave setting unit sets the high-order harmonic current of at least one of “4n+1”th-order and “4n−1”th-order to reduce a component of “4n”th-order in torque pulsation of the combined torque, and “n” is a natural number.

The present application claims priority from Japanese Patent Application No. 2017-121402 filed on Jun. 21, 2017, the entire contents of which are incorporated by reference herein.

### TECHNICAL FIELD

The present disclosure relates to a motor control device and a motor system that execute harmonic current superimposing control.

### BACKGROUND ART

A known motor control device executes control for superimposing a harmonic current on a drive current to reduce torque pulsation of a motor. For example, Patent Document 1 discloses a power generation system for reducing torque pulsation by superimposing harmonic currents.

### PRIOR ART LITERATURE

### Patent Literature

Patent Document 1: Japanese Laid-Open Patent Publication No. 2015-70781

### SUMMARY OF THE INVENTION

The superimposition of harmonic currents reduces torque pulsation in the order that is subject to torque pulsation reduction. However, a simple superimposition of harmonic current will generate new torque pulsation in an order differing from the torque pulsation reduction subject and lower the reduction effect.

One object of the present disclosure is to provide a motor control device and a motor system that effectively reduce torque pulsation.

A motor control device in accordance with the first mode of the present disclosure controls a two-phase motor, which serves as a control subject. The two-phase motor obtains a combined torque, which serves as an output torque, of A-phase and B-phase motor portions. The A-phase and B-phase motor portions being joined having a phase difference in terms of structure. The motor control device sets each of A-phase and B-phase drive currents supplied to the A-phase and B-phase motor portions to control the two-phase motor. The motor control device includes a fundamental wave setting unit and a superimposition setting unit. The fundamental wave setting unit is configured to set a sinusoidal fundamental wave current of the A-phase drive current and the B-phase drive current. The superimposing wave setting unit is configured to set a high-order harmonic current that is superimposed on the fundamental wave current. The superimposing wave setting unit sets at least one of the high-order harmonic current of “4n+1”th-order and “4n−1”th-order to reduce a component of “4n”th-order in torque pulsation of the combined torque, where “n” is a natural number.

With the above configuration, the control subject is the two-phase motor that obtains the combined torque of the A-phase motor portion and the B-phase motor portion as the output torque. The high-order harmonic current of at least one of “4n+1”th-order and “4n−1”th-order is set when superimposing a high-order harmonic current on the fundamental wave current of the A-phase drive current and the B-phase drive current. This reduces the component of “4n”th-order (“n” is a natural number) in the torque pulsation of the combined torque. Although the component of “4n±2”th-order in each of the A and B phases in the torque pulsation of the combined torque is increased by the superimposition of the harmonic current, the component is the subject of cancellation in terms of the structure of the two-phase motor. This reduces torque pulsation of the combined torque (output torque). As a result, torque pulsation can be effectively reduced.

### BRIEF DESCRIPTION OF THE DRAWINGS

The invention, together with objects and advantages thereof, may best be understood by reference to the following description of the presently preferred embodiment together with the accompanying drawings.

FIG. 1 is a schematic diagram showing the configuration of a motor of a control subject for a motor control device in accordance with an embodiment.

FIG. 2 is an exploded view of the motor shown in FIG. 1.

FIG. 3 is an exploded view of a stator shown in FIG. 1.

FIG. 4 is a block diagram of the motor control device (motor system).

FIG. 5A is a schematic diagram of current waveforms illustrating a control in accordance with a first mode.

FIG. 5B is a schematic diagram of current FFT illustrating the control in accordance with the first mode.

FIG. 5C is a schematic diagram of torque waveforms illustrating the control in accordance with the first mode.

FIG. 5D is a schematic diagram of torque FFT illustrating the control in accordance with the first mode.

FIG. 6A is a schematic diagram of current waveforms illustrating a control in accordance with a second mode.

FIG. 6B is a schematic diagram of current FFT illustrating the control in accordance with the second mode.

FIG. 6C is a schematic diagram of torque waveforms illustrating the control in accordance with the second mode.

FIG. 6D is a schematic diagram of torque FFT illustrating the control in accordance with the second mode.

FIG. 7A is a schematic diagram of current waveforms illustrating a control in accordance with a first comparative example.

FIG. 7B is a schematic diagram of current FFT illustrating the control in accordance with the first comparative example.

FIG. 7C is a schematic diagram of torque waveforms illustrating the control in accordance with first comparative example.

FIG. 7D is a schematic diagram of torque FFT illustrating the control in accordance with the first comparative example.

FIG. 8A is a schematic diagram of current waveforms illustrating a control in accordance with a second comparative example.

FIG. 8B is a schematic diagram of current FFT illustrating the control in accordance with the second comparative example.

FIG. 8C is a schematic diagram of torque waveforms illustrating the control in accordance with second comparative example.

FIG. 8D is a schematic diagram of torque FFT illustrating the control in accordance with the second comparative example.

FIG. 9 is a schematic diagram showing a gap between stator cores of A-phase and B-phase and a phase difference between A-phase and B-phase.

FIG. 10A is a schematic diagram of current waveforms illustrating a control in accordance with a third mode.

FIG. 10B is a schematic diagram of current FFT illustrating the control in accordance with the third mode.

FIG. 10C is a schematic diagram of torque waveforms illustrating the control in accordance with third mode.

FIG. 10D is a schematic diagram of torque FFT illustrating the control in accordance with the third mode.

FIG. 11A is a schematic diagram of current waveforms illustrating a control in accordance with a fourth mode.

FIG. 11B is a schematic diagram of current FFT illustrating the control in accordance with the fourth mode.

FIG. 11C is a schematic diagram of torque waveforms illustrating the control in accordance with fourth mode.

FIG. 11D is a schematic diagram of torque FFT illustrating the control in accordance with the fourth mode.

### EMBODIMENT OF THE INVENTION

One embodiment will now be described. A motor and a motor control device form a motor system. The configuration of the motor will now be described. The motor in the present embodiment is, but is not limited to, a high rotation drive source such as an electric fan device for a vehicle radiator, a blower for an air conditioner, or a fan device for cooling a battery.

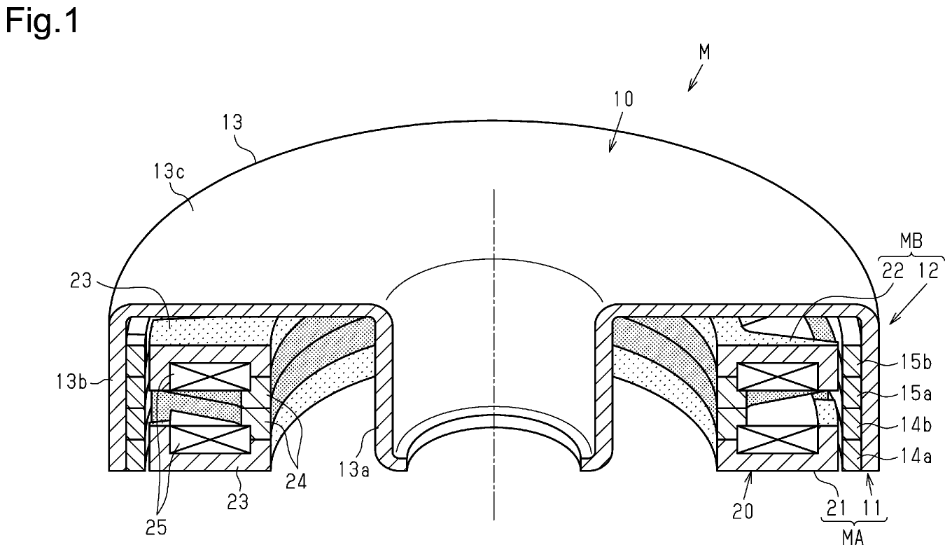

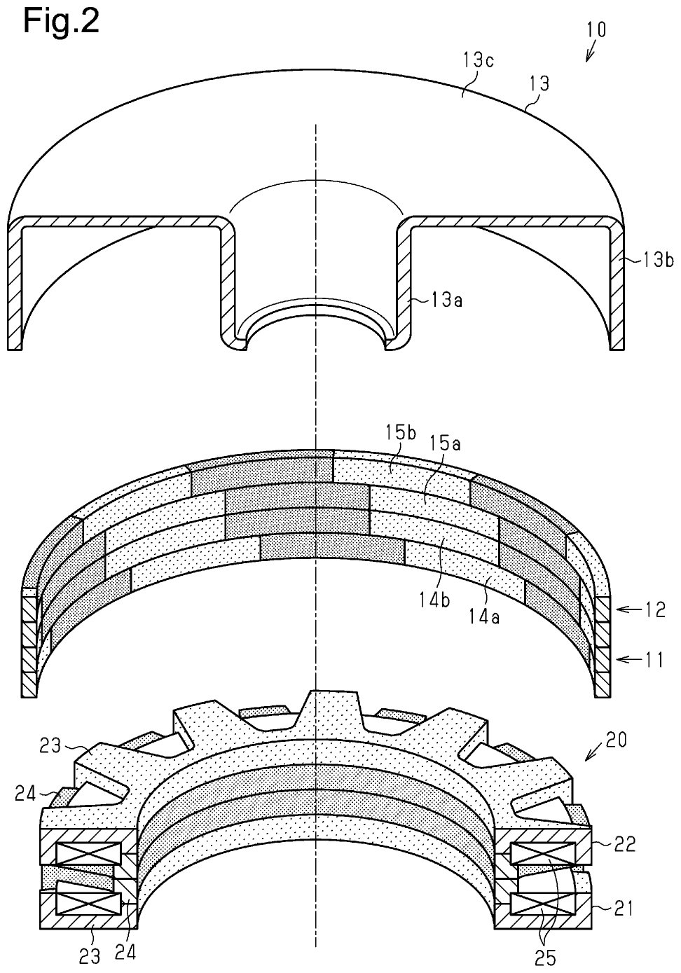

As shown in FIGS. 1 and 2, a motor M in the present embodiment is configured as a brushless motor of an outer rotor type that is arranged so that a rotor 10 covers a stator 20. In one example, the motor M is a two-phase motor. The rotor 10 includes an A-phase rotor portion 11 and a B-phase rotor portion 12. The stator 20 includes an A-phase stator portion 21 and a B-phase stator portion 22. That is, the A-phase rotor portion 11 and the A-phase stator portion 21 form an A-phase motor portion MA, and the B-phase rotor portion 12 and the B-phase stator portion 22 form a B-phase motor portion MB. The A-phase motor portion MA and the B-phase motor portion MB are joined offset from each other in a circumferential direction by a phase difference of 90 degrees in electrical angle.

The rotor 10 includes a rotor core 13, an A-phase first magnet 14a, an A-phase second magnet 14b, a B-phase first magnet 15a, and a B-phase second magnet 15b. The rotor core 13 is formed from a magnetic metal and shared by the A-phase rotor portion 11 and the B-phase rotor portion 12. The A-phase first magnet 14a and second magnet 14b are used as the A-phase rotor portion 11. The B-phase first magnet 15a and second magnet 15b are used as the B-phase rotor portion 12.

The rotor core 13 includes an inner circumferential cylindrical portion 13a, an outer circumferential cylindrical portion 13b, and an upper base 13c. The outer circumferential cylindrical portion 13b is located at an outer side of the inner circumferential cylindrical portion 13a and coaxial with the inner circumferential cylindrical portion 13a. The upper base 13c is a flat annular plate that connects an axial end of the inner circumferential cylindrical portion 13a and an axial end of the outer circumferential cylindrical portion 13b. The inner circumferential cylindrical portion 13a is used as a support of the rotor core 13 (rotor 10).

The outer circumferential cylindrical portion 13b of the rotor core 13 includes an inner circumferential surface to which the A-phase first magnet 14a, the A-phase second magnet 14b, the B-phase first magnet 15a, and the B-phase second magnet 15b are fixed. The A-phase first magnet 14a, the A-phase second magnet 14b, the B-phase first magnet 15a, and the B-phase second magnet 15b have the same configuration and each include twelve magnetic poles located at equal intervals in the circumferential direction. The magnets 14a, 14b, 15a, and 15b are arranged in the order of the A-phase first magnet 14a, the A-phase second magnet 14b, the B-phase first magnet 15a, and the B-phase second magnet 15b from the open end of the rotor core 13 toward the upper base 13c in an axial direction.

The A-phase first and second magnets 14a and 14b and the B-phase first and second magnets 15a and 15b are arranged to have a phase difference of 45 degrees in electrical angle between an A-phase reference position and a B-phase reference position. Further, in the present embodiment, in order to obtain a skew effect, the A-phase first magnet 14a and the A-phase second magnet 14b are offset by 22.5 degrees from the reference position of A-phase in opposite circumferential directions. The B-phase first magnet 15a and the B-phase second magnet 15b are offset by 22.5 degrees from the reference position of B-phase in opposite circumferential directions. As a result, the A-phase second magnet 14b and the B-phase first magnet 15a are located at the same circumferential position.

The stator 20 is formed by the A-phase stator portion 21 and the B-phase stator portion 22 that have the same configuration and are arranged next to each other in the axial direction. The A-phase stator portion 21 is located at a lower side in the axial direction (side of open end of rotor core 13), and the B-phase stator portion 22 is located at an upper side in the axial direction (side of upper base 13c of rotor core 13). That is, the A-phase stator portion 21 opposes the A-phase first magnet 14a and second magnet 14b (A-phase rotor portion 11) in a radial direction, and the B-phase stator portion 22 opposes the B-phase first magnet 15a and second magnet 15b (B-phase rotor portion 12) in the radial direction.

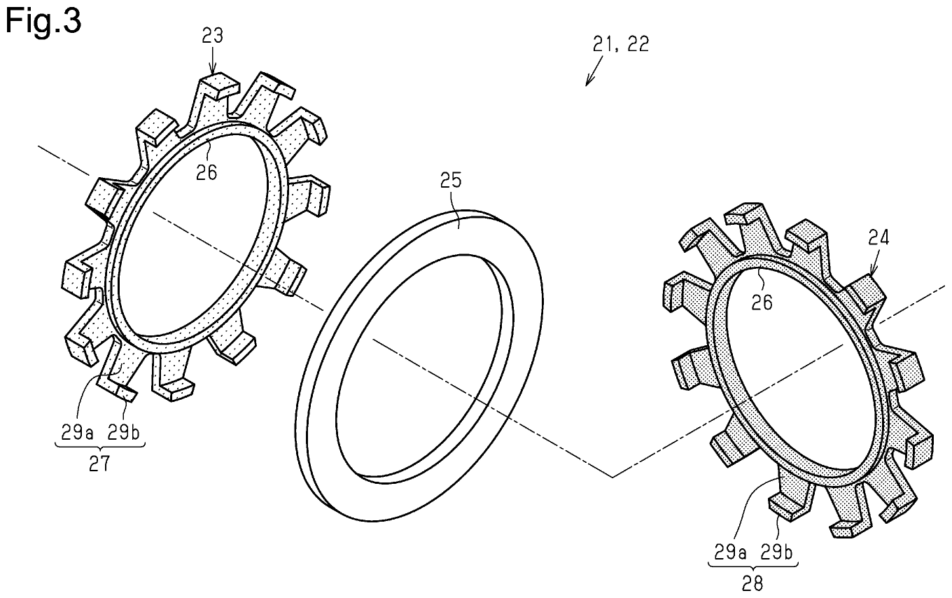

As shown in FIG. 3, the A-phase stator portion 21 and the B-phase stator portion 22 each include a first stator core 23, a second stator core 24, and a coil 25. The stator cores 23 and 24 have the same configuration, and the coil 25 is located between the stator cores 23 and 24.

The first stator core 23 and the second stator core 24 include cylindrical portions 26, claw-shaped magnetic poles 27, and claw-shaped magnetic poles 28. The claw-shaped magnetic poles 27 and 28 extend circumferentially outward from the cylindrical portions 26. In the present embodiment, there are twelve claw-shaped magnetic poles 27 and twelve claw-shaped magnetic poles 28. The claw-shaped magnetic poles formed on the first stator core 23 will be referred to as the first magnetic poles 27, and the claw-shaped magnetic poles formed on the second stator core 24 will be referred to as second claw-shaped magnetic poles 28. The first and second claw-shaped magnetic poles 27 and 28 are arranged at equal intervals (30-degree intervals) in the circumferential direction. The first and second claw-shaped magnetic poles 27 and 28 each include a radially extended portion 29a and a magnetic pole portion 29b. The radially extended portion 29a extends radially outward from the cylindrical portion 26. The magnetic pole portion 29b is bent perpendicularly from a distal end of the radially extended portion 29a and extends in the axial direction. The first stator core 23 and the second stator core 24 are arranged so that the first claw-shaped magnetic poles 27 and the second claw-shaped magnetic poles 28 extend toward each other. Further, the first stator core 23 and the second stator core 24 are coupled so that the magnetic pole portions 29b of the claw-shaped magnetic poles 27 and the magnetic pole portions 29b of the claw-shaped magnetic poles 28 are alternately arranged at equal intervals in the circumferential direction. The number of the magnetic pole portions 29b is twenty-four (24 magnetic poles).

The first stator core 23 and the second stator core 24 hold the coil 25 between them in the axial direction. The coil 25 is formed by winding wires around an annular bobbin, which extends around the cylindrical portions 26 of the stator cores 23 and 24. Specifically, the coil 25 is located between the radially extended portion 29a of the first claw-shaped magnetic poles 27 and the radially extended portion 29a of the second claw-shaped magnetic poles 28 in the axial direction, and the coil 25 is located between the cylindrical portions 26 of the first stator core 23 and the second stator core 24 and the magnetic pole portions 29b of the first claw-shaped magnetic poles 27 and the second claw-shaped magnetic poles 28 in the radial direction. Accordingly, the A-phase stator portion 21 and the B-phase stator portion 22 each form a Lundell-type construction.

The A-phase stator portion 21 and the B-phase stator portion 22 are arranged to have a phase difference of 45 degrees in electrical angle. In this case, the direction in which the A-phase stator portion 21 is offset 45 degrees in electrical angle from the B-phase stator portion 22 is set to be opposite of the direction in which the A-phase rotor portion 11 (A-phase first magnet 14a and second magnet 14b) is offset 45 degrees in electrical angle from the B-phase rotor portion 12 (B-phase first magnet 15a and second magnet 15b) so that the A-phase motor portion MA and the B-phase motor portion MB are configured to have a phase difference of 90 degrees in electrical angle. The A-phase motor portion MA and the B-phase motor portion MB are each rotated and driven when the corresponding coils 25 of the A-phase stator portion 21 and the B-phase stator portion 22 are supplied with drive current.

A motor control device, of which the control subject is the motor M, will now be described.

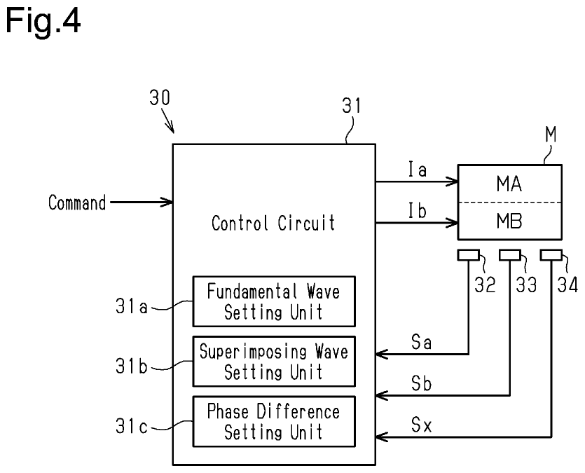

As shown in FIG. 4, a motor control device 30 of the present embodiment is configured to include a control circuit 31. The control circuit 31 generates and supplies A-phase drive current Ia and B-phase drive current Ib based on a command to drive the motor M (A-phase motor portion MA and B-phase motor portion MB).

When generating the A-phase drive current Ia and the B-phase drive current Ib, the control circuit 31 receives an A-phase detection signal Sa that corresponds to the A-phase drive current Ia from an A-phase current sensor 32 and a B-phase current detection signal Sb that corresponds to the B-phase drive current Ib from a B-phase current sensor 33. Further, the control circuit 31 receives a rotation position detection signal Sx corresponding to a rotation position (rotation angle) of the rotor 10 of the motor M from a rotation position detection sensor 34. The control circuit 31 detects the amplitude and the phase of the A-phase drive current Ia and the B-phase drive current Ib from the A-phase current detection signal Sa and the B-phase current detection signal Sb. Further, the control circuit 31 detects the rotation position of the rotor 10 from the rotation position detection signal Sx.

The control circuit 31 includes a fundamental wave setting unit 31a, a superimposing wave setting unit 31b, and a phase difference setting unit 31c. The fundamental wave setting unit 31a sets a sinusoidal fundamental wave current included in the A-phase drive current Ia and the B-phase drive current Ib based on the amplitudes and phases of the A-phase drive current Ia and the B-phase drive current Ib, the rotation position of the rotor 10, and the drive command. The superimposing wave setting unit 31b superimposes a high-order harmonic current on the fundamental wave current set by the fundamental wave setting unit 31a. In the present embodiment, the high-order harmonic current is a third-order harmonic current. Further in this case, the magnitude (amplitude) of the third-order harmonic current is set to a predetermined proportion smaller than the fundamental wave current. The phase difference setting unit 31c sets the phase difference of the A-phase drive current Ia and the B-phase drive current Ib. In this case, the phase difference can be set separately prior to the superimposition of the third-order harmonic current on the fundamental wave current. Alternatively, the phase difference can be set subsequent to the superimposition.

### First Comparative Example

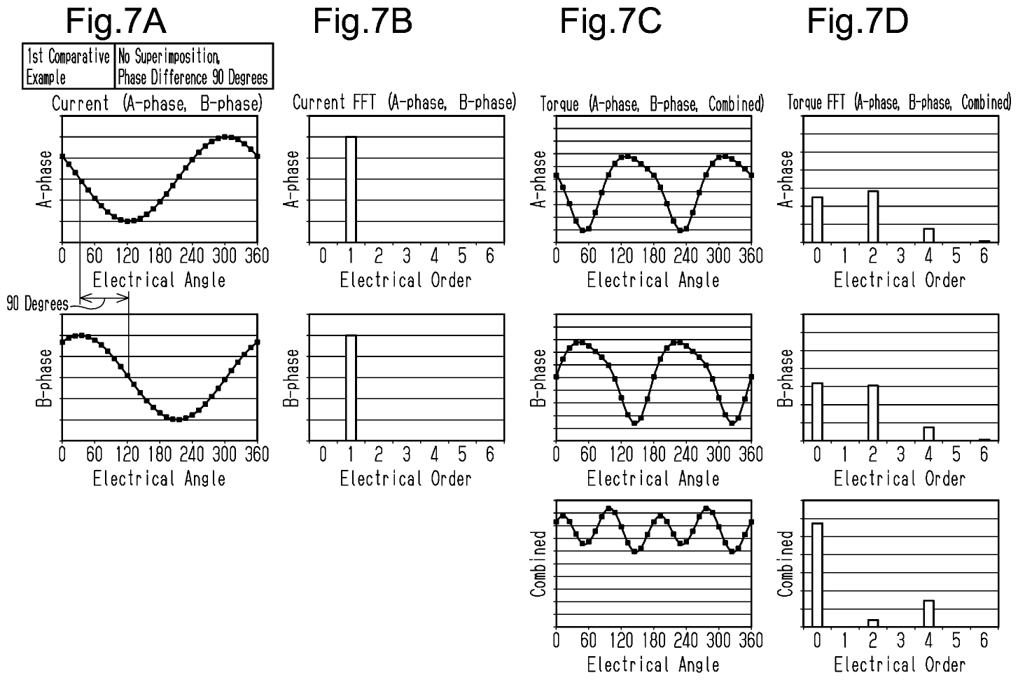

The first comparative example in which the A-phase drive current Ia and the B-phase drive current Ib are the sinusoidal fundamental wave currents will now be described with reference to FIGS. 7A and 7D. The A-phase motor portion MA and the B-phase motor portion MB, which form the motor M of the control subject, are configured to have a phase difference of 90 degrees in electrical angle. Accordingly, the phase difference of the A-phase drive current Ia and the B-phase drive current Ib in the first comparative example is generally set to 90 degrees.

The current waveforms shown in FIG. 7A indicate that when the A-phase drive current Ia and the B-phase drive current Ib are the sinusoidal fundamental wave currents, the phase difference is 90 degrees. As shown in FIG. 7B, in a frequency analysis of the current waveforms using a Fourier transform (current FFT), the A-phase drive current Ia and the B-phase drive current Ib are the fundamental wave currents (first-order harmonic current), and a high-order harmonic current is not superimposed.

Based on the supply of such A-phase drive current Ia and B-phase drive current Ib, the torque waveforms of the A-phase motor portion MA and the B-phase motor portion MB of the motor M are greatly distorted and deviate from the sine wave shapes as shown in FIG. 7C. Specifically, one of the upper part and the lower part of the torque waveform of the A-phase motor portion MA is shaped asymmetrically to the other one of the upper part and the lower part of the torque waveform of the B-phase motor portion MB. Further, the phase difference of the torque of the A-phase motor portion MA and the B-phase motor portion MB is offset several degrees from 90 degrees in electrical angle. Therefore, the cancellation effect is insufficient in phases A and B in the combined torque of the A-phase and B-phase motor portions MA and MB. This produces relatively large pulsations.

Moreover, as shown in FIG. 7D, in a frequency analysis of torque waveforms using a Fourier transform (torque FFT), a second-order component and a fourth-order component are mainly produced in addition to a zero-order component in the torque FFT of the A-phase motor portion MA and the B-phase motor portion MB. Further, the magnitude of the second-order component greatly differs between the A-phase and B-phase. The second-order component will be subject to cancellation in the A-phase and B-phase when combined. However, the difference in magnitude between the A-phase and B-phase results in the second-order component slightly remaining in the combined torque. The fourth-order components in the A-phase and B-phase are added when combined. Thus, the combined torque has a relatively large fourth-order component.

As a result, in the first comparative example shown in FIGS. 7A to 7D, relatively large torque pulsation including the second-order component and the fourth-order component is produced in the combined torque of the A-phase motor portion MA and the B-phase motor portion MB, that is, in the output torque of the motor M.

### Second Mode of Present Embodiment

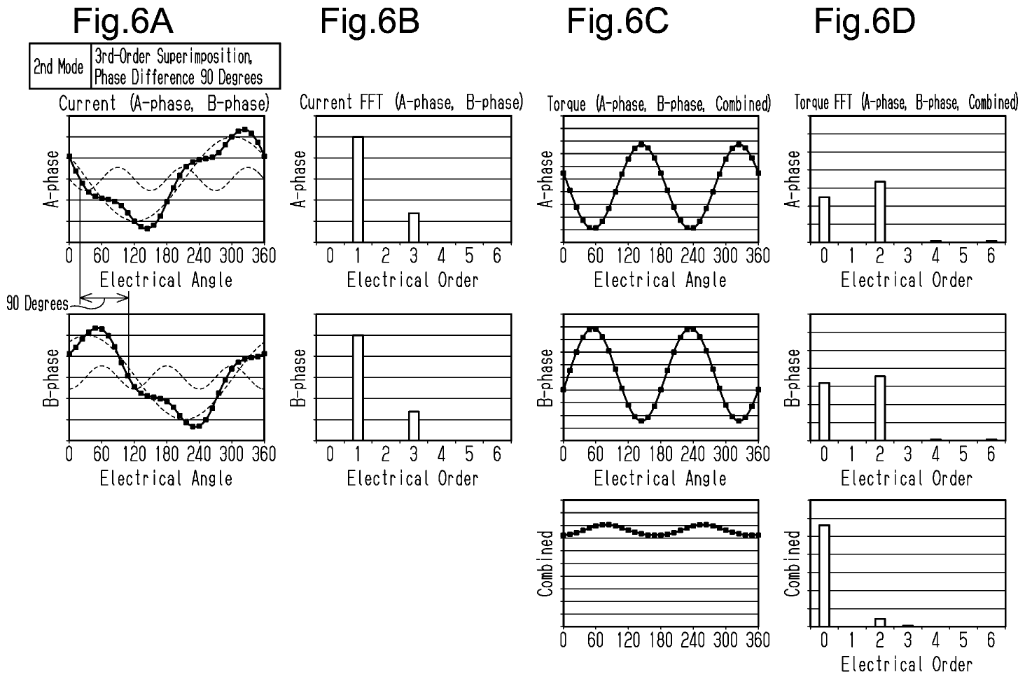

A second mode of the present embodiment in which the third-order harmonic current is superimposed on the fundamental wave current of the A-phase drive current Ia and the B-phase drive current Ib will now be described with reference to FIGS. 6A to 6D. In the second mode, the phase difference of the A-phase drive current Ia and the B-phase drive current Ib is also set to 90 degrees.

The current waveforms shown in FIG. 6A indicate that the phase difference of the current waveforms is 90 degrees when the A-phase drive current Ia and the B-phase drive current Ib are the fundamental wave currents on which the third-order harmonic current is superimposed. The frequency analysis of current waveforms (current FFT) shown in FIG. 6B indicates that the A-phase drive current Ia and the B-phase drive current Ib are the fundamental wave currents (first-order harmonic current) on which the third-order harmonic current is superimposed. The magnitude of the third-order harmonic current is set to, for example, approximately ¼ of the fundamental wave current.

Based on the supply of such A-phase drive current Ia and B-phase drive current Ib, the torque waveforms of the A-phase motor portion MA and the B-phase motor portion MB of the motor M are less distorted and more approximate to sine wave shapes, as shown in FIG. 6C. Specifically, one of the upper part and the lower part of the torque waveform of the A-phase motor portion MA is shaped symmetrically to the other one of the upper part and the lower part of the torque waveform of the B-phase motor portion MB when the phase difference is eliminated. The phase difference of the torque of the A-phase motor portion MA and the B-phase motor portion MB remains offset several degrees from 90 degrees in electrical angle. Therefore, the cancellation effect is sufficient in the A-phase and B-phase, and the torque pulsation is reduced in the combined torque of the A-phase motor portion MA and the B-phase motor portion MB.

Moreover, as shown by the frequency analysis of torque waveforms (torque FFT) in FIG. 6D, the second-order component is mainly produced in addition to the zero-order component in the torque FFT of the A-phase motor portion MA and the B-phase motor portion MB, and the fourth-order component is eliminated. This is because the third-order harmonic current contributes to elimination of the fourth-order component of the torque pulsation. The third-order harmonic current increases the second-order component more than the first comparative example. However, the second-order component becomes the subject of cancellation in A-phase and the B-phase when combined. Thus, the second-order component is sufficiently decreased by the sufficient cancellation. The second-order component of the torque pulsation slightly remains in the combined torque due to the difference between the A-phase and B-phase.

As a result, in the second mode of the present embodiment shown in FIGS. 6A to 6D, although the second-order component slightly remains in the combined torque of the A-phase motor portion MA and the B-phase motor portion MB, that is, in the output torque of the motor M, the fourth-order component is substantially eliminated. Thus, the torque change is stabilized, and the torque pulsation is relatively small.

### Second Comparative Example

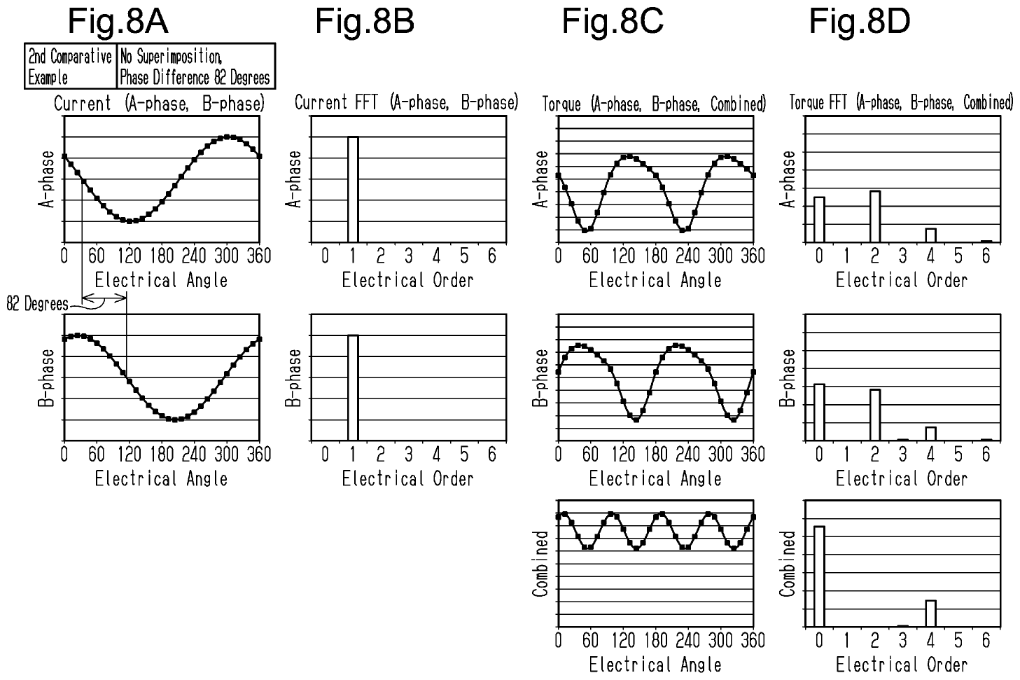

A second comparative example in which the A-phase drive current Ia and the B-phase drive current Ib are the sinusoidal fundamental wave currents (no superimposition of high-order harmonic current) and the phase difference is set to 82 degrees, which is smaller than 90 degrees, will now be described with reference to FIGS. 8A to 8D.

As described above, the A-phase motor portion MA and the B-phase motor portion MB that form the motor M, which is subject to control, have a phase difference of 90 degrees in electrical angle in terms of the structure. Thus, the phase difference of the A-phase drive current Ia and the B-phase drive current Ib is generally 90 degrees in electrical angle. Further, the present embodiment employs a structure in which the second stator cores 24 of the A-phase stator portion 21 and the B-phase stator portion 22 forming the A-phase motor portion MA and the B-phase motor portion MB are in contact with each other to reduce the size in the axial direction. This causes a situation in which magnetic interference easily occurs between the A-phase and B-phase thereby resulting in torque pulsation. Accordingly, the present inventors have found that when the phase difference of the A-phase drive current Ia and the B-phase drive current Ib is decreased from 90 degrees, the magnetic interference is decreased between the A-phase and B-phase thereby reducing the torque pulsation.

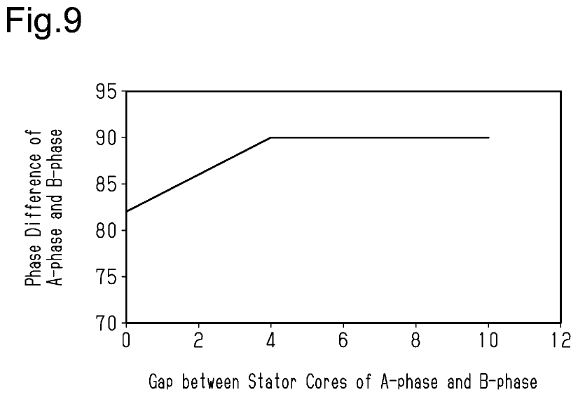

FIG. 9 illustrates the optimal phase difference between the A-phase and B-phase (phase difference of A-phase drive current Ia and B-phase drive current Ib) for reducing the torque pulsation with respect to an interval (gap) between the A-phase stator portion 21 and the B-phase stator portion 22. In the present embodiment, when the interval (gap) is 0 mm, the optimal phase difference is 82 degrees in a state in which the A-phase stator portion 21 and the B-phase stator portion 22 are in contact (zero interval). As the interval (gap) increases, the optimal phase difference becomes closer to 90 degrees from 82 degrees. Then, when the interval (gap) is 4 mm, the optimal phase difference between the A-phase and B-phase is 90 degrees. Thereafter, even in a case where the interval (gap) increases, the optimal phase difference between the A-phase and B-phase remains at 90 degrees, meaning that there is no magnetic interference. In the second comparative example, the phase difference of the A-phase drive current Ia and the B-phase drive current Ib is set to 82 degrees.

The current waveforms shown in FIG. 8A indicate that when the A-phase drive current Ia and the B-phase drive current Ib are the fundamental wave currents, the phase difference is 82 degrees. The frequency analysis of current waveforms (current FFT) shown in FIG. 8B indicates that the A-phase drive current Ia and the B-phase drive current Ib are the fundamental wave currents (first-order harmonic current) and a high-order harmonic current is not superimposed.

Based on the supply of such A-phase drive current Ia and B-phase drive current Ib, the torque waveforms of the A-phase motor portion MA and the B-phase motor portion MB of the motor M remain distorted since a high-order harmonic current is not superimposed as shown in FIG. 8C. Nevertheless, the phase difference is 90 degrees in electrical angle, and the phase deviation, shown in FIG. 7 of the first comparative example, is reduced. Therefore, the combined torque of the A-phase motor portion MA and the B-phase motor portion MB improves the cancellation effect since the phase deviation is reduced. This reduces the torque pulsation.

Moreover, as shown by the frequency analysis of torque waveforms (torque FFT) in FIG. 8D, the second-order component and the fourth-order component are mainly produced in addition to the zero-order component in the torque FFT of the A-phase motor portion MA and the B-phase motor portion MB. However, the second-order component is substantially equal in magnitude in the A-phase and B-phase. When the second-order component, which is the subject of cancellation, is substantially equal in the A-phase and B-phase, the second-order component of the combined torque is eliminated. The fourth-order component still remains due to the addition.

As a result, in accordance with the second comparative example shown in FIGS. 8A to 8D, although the fourth-order component still remains, the second-order component is substantially eliminated from the combined torque of the A-phase motor portion MA and the B-phase motor portion MB, that is, the output torque of the motor M. Thus, some improvements in the torque pulsation can be expected.

### First Mode of Present Embodiment

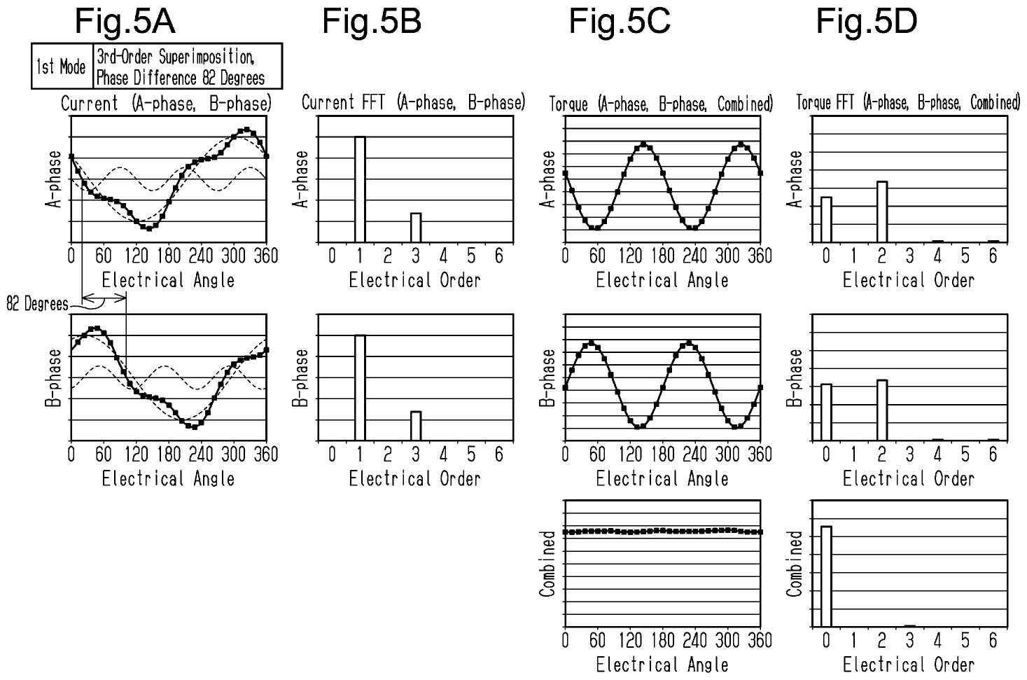

Taking into consideration what is described above, a first mode of the present embodiment will now be described with reference to FIGS. 5A to 5D. In the first mode of the present embodiment, the third-order harmonic current is superimposed on the fundamental wave currents of the A-phase drive current Ia and the B-phase drive current Ib. Further, the phase difference is set to 82 degrees, which is smaller than 90 degrees.

The current waveforms shown in FIG. 5A indicate that the phase difference of the current waveforms is 82 degrees when the A-phase drive current Ia and the B-phase drive current Ib are the fundamental wave currents on which the third-order harmonic current is superimposed. The frequency analysis of current waveforms (current FFT) shown in FIG. 5B indicates that the A-phase drive current Ia and the B-phase drive current Ib are the fundamental wave currents (first-order harmonic current) on which the third-order harmonic current is superimposed.

Based on the supply of such A-phase drive current Ia and B-phase drive current Ib, the torque waveforms of the A-phase motor portion MA and the B-phase motor portion MB of the motor M are less distorted and more approximate to the sine wave shapes as shown in FIG. 5C. That is, one of the upper part and the lower part of the torque waveform of the A-phase motor portion MA is shaped symmetrically to the other one of the upper part and the lower part of the torque waveform of the B-phase motor portion MB. Further, the torque of the A-phase motor portion MA and the B-phase motor portion MB have a phase difference of 90 degrees in electrical angle thereby reducing the phase difference. Therefore, the combined torque of the A-phase motor portion MA and the B-phase motor portion MB obtains a further appropriate cancellation effect resulting from the superimposition of the third-order harmonic current and the reduced phase deviation. Accordingly, the torque change is further stabilized, and torque pulsation is extremely small.

As shown by the frequency analysis of torque waveforms (torque FFT) in FIG. 5D, the second-order component is mainly produced in addition to the zero-order component in the torque FFT of the A-phase motor portion MA and the B-phase motor portion MB, and the fourth-order component is eliminated by the superimposition of the third-order harmonic current. Further, although the third-order harmonic current increases the second-order component, the reduced phase deviation further appropriately cancels the second-order component in the A-phase and B-phase when combined. This eliminates the second-order component of the torque pulsation of the combined torque.

As a result, in the first mode of the present embodiment shown in FIGS. 5A to 5D, the second-order component and the fourth-order component are substantially eliminated from the combined torque of the A-phase motor portion MA and the B-phase motor portion MB, that is, the output torque of the motor M. Accordingly, the torque change is further stabilized, and torque pulsation is extremely small.

Therefore, the motor control device 30 of the present embodiment sets the sinusoidal fundamental wave current included in the A-phase drive current Ia and the B-phase drive current Ib (fundamental wave setting unit 31a), superimposes the third-order harmonic current on the fundamental wave current (superimposing wave setting unit 31b), sets the phase difference of the A-phase and B-phase to 82 degrees (phase difference setting unit 31c), and controls the two-phase motor M, which is formed by the A-phase motor portion MA and the B-phase motor portion M. In accordance with the first mode, the torque pulsation of the motor M is further effectively reduced, and the motor M produces less vibration and less noise. The torque pulsation of the motor M can also be effectively reduced in accordance with the second mode in which the phase difference of the A-phase and B-phase is 90 degrees, and only the third-order harmonic current is superimposed.

The third-order harmonic current is superimposed in the above description. However, the fifth-order harmonic current may be superimposed (third mode). Alternatively, the third and the-fifth harmonic current may be superimposed (fourth mode).

### Third Mode of Present Embodiment

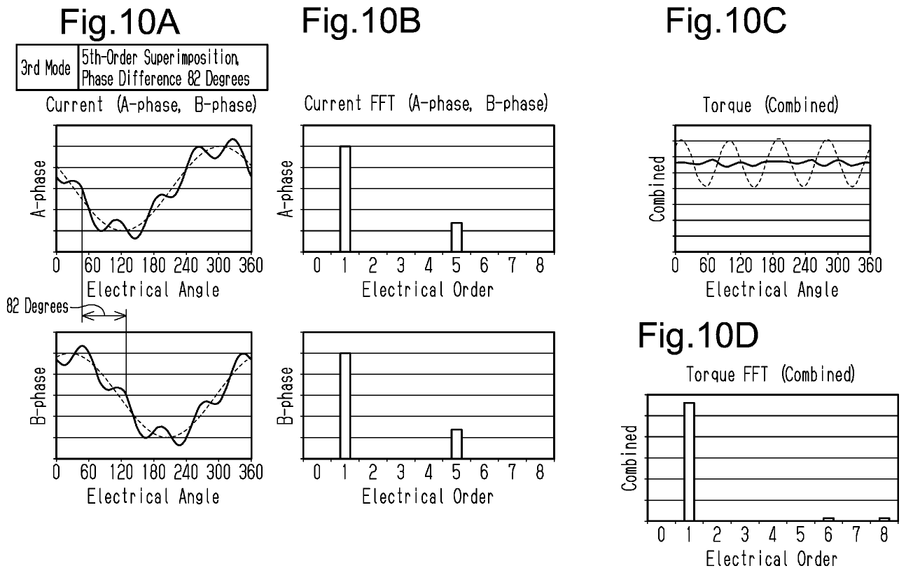

The third mode of the present embodiment in which the fifth-order harmonic current is superimposed on the fundamental wave current of the A-phase drive current Ia and the B-phase drive current Ib (phase difference is set to 82 degrees) will now be described with reference to FIGS. 10A to 10D.

The current waveforms shown in FIG. 10A indicate that the phase difference of the current waveforms is 82 degrees when the A-phase drive current Ia and the B-phase drive current Ib are the fundamental wave currents on which the fifth-order harmonic current is superimposed. The frequency analysis of current waveforms (current FFT) shown in FIG. 10B indicates that the A-phase drive current Ia and the B-phase drive current Ib are the fundamental wave currents (first-order harmonic current) on which the fifth-order harmonic current is superimposed. The magnitude of the fifth-order harmonic current is set to, for example, approximately ¼ of the fundamental wave current in the same manner as the third-order harmonic current described above.

Based on the supply of such A-phase drive current Ia and B-phase drive current Ib, the torque waveforms of the A-phase motor portion MA and of the B-phase motor portion MB of the motor M have little distortion (not shown) in the same manner as when the third-order harmonic current is superimposed as shown in FIG. 5C. Further, the torque waveforms of A-phase and B-phase are adjusted so that the phase difference is 90 degrees. Accordingly, as shown by the waveforms of the combined torque in FIG. 10C, further appropriate cancellation effect is obtained in the A-phase and B-phase. Thus, the torque change is further stabilized, and torque pulsation is extremely small.

As shown by the frequency analysis of waveforms of the combined torque (torque FFT) in FIG. 10D, the fourth-order component can also be eliminated in the torque FFT of the A-phase motor portion MA and the B-phase motor portion MB by the superimposition of the fifth-order harmonic current. Although the fifth-order harmonic current increases a component of the sixth-order, the sixth-order component is appropriately cancelled in the A-phase and B-phase when combined. Thus, the sixth-order component in the torque pulsation of the combined torque is sufficiently reduced. The components of a high order, such as the sixth-order component and an eighth-order component, slightly remain. However, torque pulsation can be effectively reduced.

### Fourth Mode of Present Embodiment

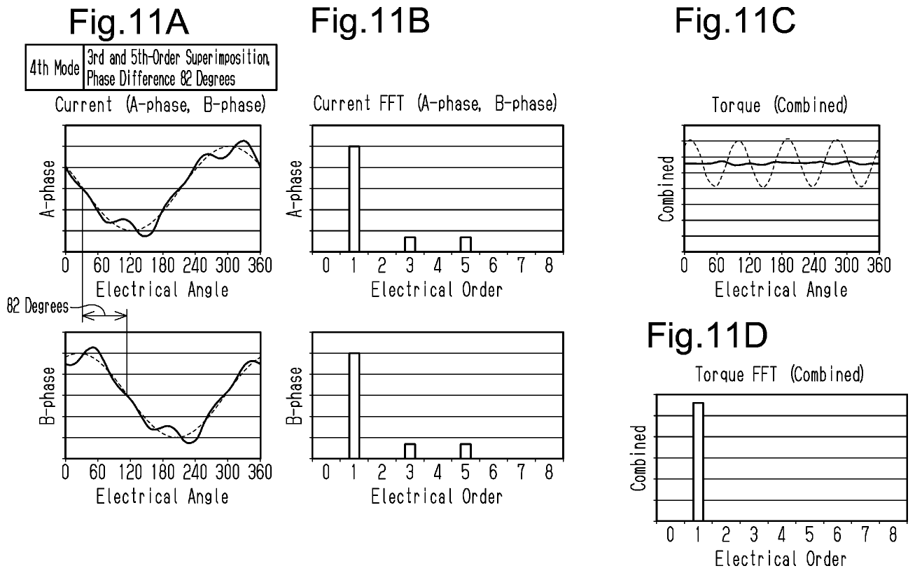

The fourth mode of the present embodiment in which the A-phase drive current Ia and the B-phase drive current Ib are the fundamental wave currents on which the third and fifth-order harmonic currents are superimposed (phase difference is set to 82 degrees) will now be described with reference to FIGS. 11A to 11D.

The current waveforms shown in FIG. 11A indicate that the phase difference of the current waveforms is 82 degrees when the A-phase drive current Ia and the B-phase drive current Ib are the fundamental wave currents on which the third and fifth-order harmonic currents are superimposed. The frequency analysis of current waveforms (current FFT) shown in FIG. 11B indicates that the A-phase drive current Ia and the B-phase drive current Ib are the fundamental wave currents (first-order harmonic current) on which the third and fifth-order harmonic currents are superimposed. The magnitudes of the third and fifth-order harmonic currents are set to, for example, an additional half of the third-order (or fifth-order) harmonic current described above, that is, approximately ⅛ of the fundamental wave current. Further, the magnitudes of the third and fifth-order harmonic currents are set to be the same.

The torque of the A-phase motor portion MA and the B-phase motor portion MB of the motor M based on the supply of such A-phase drive current Ia and B-phase drive current Ib has little distortion in the torque waveforms of A-phase and B-phase (not shown) in the same manner as when the third-order (or fifth-order shown in FIG. 10C) harmonic current is superimposed as shown in FIG. 5C. Further, the torque waveforms of A-phase and B-phase are adjusted so that the phase difference is 90 degrees. Thus, as shown by the waveforms of the combined torque in FIG. 11C, further appropriate cancellation effect is obtained in the A-phase and B-phase. Accordingly, the torque change is further stabilized, and torque pulsation is extremely small.

Moreover, as shown by the frequency analysis of waveforms of the combined torque (torque FFT) in FIG. 11D, the second-order component, the fourth-order component, the sixth-order component, and the eighth-order component can be eliminated from the torque FFT of the A-phase motor portion MA and the B-phase motor portion MB. This further effectively reduces the torque pulsation.

The present embodiment has the following advantages.

(1) The control subject of the motor control device 30 is the two-phase motor M that obtains the combined torque of the A-phase motor portion MA and the B-phase motor portion MB as the output torque. When superimposing a high-order harmonic current on the fundamental wave current of the A-phase drive current Ia and the B-phase drive current Ib, the third-order (“4n−1”th-order) or the fifth-order (“4n+1”th-order) harmonic current is set (first to fourth modes of the present embodiment). This reduces the fourth-order (“4n”th-order) component in the torque pulsation of the combined torque. When the harmonic current is superimposed, the second-order or the sixth-order component in the A-phase and B-phase increases in the torque pulsation of the combined torque. However, with the structure of the two-phase motor M, the components cancel each other and reduce the torque pulsation in the combined torque (output torque). As a result, the torque pulsation is effectively reduced.

(2) In accordance with the first to third modes of the present embodiment in which one of the third or fifth of the high-order harmonic current when superimposing a high-order harmonic current, the torque pulsation can be sufficiently reduced with a relatively simple configuration of the superimposing wave setting unit 31b (control circuit 31).

(3) In accordance with the fourth mode of the present embodiment in which both of the third and the fifth of the high-order harmonic current are set when superimposing a high-order harmonic current, the torque pulsation can be reduced in a sophisticated manner.

(4) The phase difference of the A-phase drive current Ia and the B-phase drive current Ib is set to 82 degrees (80 degrees or greater and less than 90 degrees) for the A-phase motor portion MA and the B-phase motor portion MB, which are constructed to have a phase difference of 90 degrees in electrical angle. The two-phase motor M of the present embodiment includes the A-phase motor portion MA and the B-phase motor portion MB that bring the stator cores 24 of the A-phase and B-phase into contact with each other. Each of the A-phase motor portion MA and the B-phase motor portion MB includes the pair of stator cores 23 and 24, which include the magnetic pole portions 29b, and the coil 25 arranged between the stator cores 23 and 24. In the two-phase motor M of the present embodiment, a magnetic interference may occur between the A-phase and B-phase. This generates a slight phase deviation between the A-phase and B-phase and lowers the cancellation effect when the second-order or sixth-order component, which is increased by the torque pulsation in each of the A-phase and B-phase produced by superimposing the third-order or fifth-order harmonic current, cancel each other. Accordingly, the setting of the phase difference of the A-phase drive current Ia and the B-phase drive current Ib to 80 degrees or greater and less than 90 degrees improves this situation. As a result, a further phase adjustment in addition to superimposing a high-order harmonic current reduces the torque pulsation more effectively. Further, in this case, simple changes are made to the control. Thus, there is no need for a modification in the structure (phase difference) of the A-phase motor portion MA and the B-phase motor portion MB.

(5) The phase difference of the A-phase drive current Ia and the B-phase drive current Ib is set to 80 degrees or greater and less than 90 degrees, and the A-phase motor portion MA and the B-phase motor portion MB are configured to have a phase difference of 90 degrees in electrical angle. This limits cogging torque to a low level when the motor M is not operating.

(6) The motor M is used as a high rotation drive source such as an electric fan device for a vehicle radiator, a blower for an air conditioner, or a fan device for cooling a battery. Thus, the torque pulsation of the output torque of the motor M allows for sufficient reduction in vibration and noise of these devices.

The above described embodiment may be modified as follows.

The third-order or the fifth-order harmonic current is superimposed on the A-phase drive current Ia and the B-phase drive current Ib to reduce the fourth-order component of the torque pulsation of the two-phase (A-phase and B-phase) motor M. The increases in the second-order or the sixth-order components of A-phase and B-phase in the torque pulsation resulting from the superimposition are cancelled by the configuration of the motor M. However, there is no limit to the orders.

That is, the harmonic current of “4n±1”th-order may be superimposed to reduce the component of “4n”th-order (n is natural) of the torque pulsation. The increase in “4n±2”th-order component may be cancelled by the configuration of the motor M (n=1 in the above embodiment).

The magnitude of high-order harmonic current is set to approximately ¼ of the fundamental wave current in the first to third modes of the above embodiment, and the magnitude of the high-order harmonic current is set to approximately ⅛ of the fundamental wave current in the fourth mode. The magnitude of the current may be changed.

In a case where both of the third and the fifth harmonic currents are superimposed as in the fourth mode of the above embodiment, the third and the fifth harmonic currents have the same magnitude (amplitude). However, the magnitude of the currents may be changed for each order.

The phase difference of the A-phase drive current Ia and the B-phase drive current Ib is set to 90 degrees (no phase adjustment) in the second mode of the above embodiment, and 82 degrees in the first, third, and fourth mode of the above embodiment. However, the angle can be changed. It is preferred that the phase difference is set in an effective range, which is 80 degrees or greater and less than 90 degrees, especially in a case where the magnetism may interfere between the A-phase motor portion MA and the B-phase motor portion MB.

In the first, third, and fourth modes of the above embodiment, the phase difference of the A-phase drive current Ia and the B-phase drive current Ib is controlled to be 82 degrees. However, for example, even when the phase difference of the A-phase drive current Ia and the B-phase drive current Ib is set to 90 degrees (no phase adjustment) and the A-phase motor portion MA and the B-phase motor portion MB are configured to have a phase difference of 98 degrees in electrical angle, the same cancellation effect can be obtained in the A-phase and B-phase. In this case, the effective range of the phase difference between the A-phase motor portion MA and the B-phase motor portion MB is preferably greater than 90 degrees and less than or equal to 100 degrees. Further, the phase difference of the A-phase and B-phase in terms of control may be changed along with the phase difference in terms of structure.

The motor M (A-phase motor portion MA and B-phase motor portion MB) may have any configuration.

For example, in the A-phase stator portion 21 and the B-phase stator portion 22, the stator cores 24 of A-phase and B-phase are configured to be in contact with each other. However, the stator cores 24 may be separated from each other, or a non-magnetic body or the like may be arranged between the stator cores 24 of A-phase and B-phase.

For example, the A-phase stator portion 21 and the B-phase stator portion 22 are each of a Lundell-type construction including the pair of the stator cores 23 and 24, which include the magnetic pole portions 29b, and the coil 25, which is arranged between the pair of the stator cores 23 and 24. However, the A-phase stator portion 21 and the B-phase stator portion 22 may each be a known stator that includes a stator core having teeth that extend in a circumferential direction and around which a coil is wound.

For example, the A-phase rotor portion 11 and B-phase rotor portion 12 use the magnets 14a, 14b, 15a, and 15b, which are divided into two in the axial direction for the A-phase and B-phase. Further, the A-phase rotor portion 11 and B-phase rotor portion 12 have a skewed structure, in which the magnets 14a, 14b, 15a, and 15b are offset in the circumferential direction. However, typical magnets that are not divided in the axial direction for phases and not of a skewed structure may be used. Each phase may have a skewed structure that is divided into three or more.

The present disclosure described in accordance with examples is to be considered as illustrative and not restrictive, and the present disclosure is not to be limited to the details given herein, but may be modified within the scope and equivalence of the appended claims.

1. A motor control device for controlling a two-phase motor, which serves as a control subject, wherein the two-phase motor obtains a combined torque, which serves as an output torque, of A-phase and B-phase motor portions, the A-phase and B-phase motor portions being joined having a phase difference in terms of structure, and the motor control device sets each of A-phase and B-phase drive currents supplied to the A-phase and B-phase motor portions to control the two-phase motor, the device comprising:
a fundamental wave setting unit that sets a sinusoidal fundamental wave current of the A-phase and B-phase drive currents; and
a superimposing wave setting unit that sets a high-order harmonic current superimposed on the fundamental wave current, wherein
the superimposing wave setting unit sets the high-order harmonic current of at least one of “4n+1”th-order and “4n−1”th-order to reduce a component of “4n”th-order in torque pulsation of the combined torque, and
“n” is a natural number.

2. The motor control device according to claim 1, wherein the A-phase and B-phase motor portions have a phase difference of 90 degrees in an electrical angle in terms of structure.

3. The motor control device according to claim 1, wherein the superimposing wave setting unit sets the high-order harmonic current of one of “4n−1”th-order and “4n+1”th-order.

4. The motor control device according to claim 1, wherein the superimposing wave setting unit sets the high-order harmonic current of both of “4n−1”th-order and “4n+1”th-order.

5. The motor control device according to claim 1, further comprising a phase difference setting unit that sets a phase difference of the A-phase and B-phase drive currents,
wherein the phase difference setting unit sets the phase difference of the A-phase and B-phase drive currents to be 80 degrees or greater and less than 90 degrees.

6. The motor control device according to claim 1, wherein each of the A-phase and B-phase motor portions includes two stator cores including a plurality of magnetic poles, and a coil arranged between the two stator cores.

7. A motor system, comprising:
a two-phase motor that obtains a combined torque of A-phase and B-phase motor portions, the A-phase and B-phase motor portions being joined and having a phase difference in terms of structure, as an output torque; and
the motor control device according to claim 1 that sets each of A-phase and B-phase drive currents supplied to the A-phase and B-phase motor portions to control the two-phase motor.
